(19) United States
(12) Patent Application Publication
(10) Pub. No.: US 2013/0048423 A1
(43) Pub. Date: Feb. 28, 2013

(54) SUPPORTED DAVIT ARM EXTENSION ASSEMBLY FOR CABLE SUSPENDED DESCENT APPARATUS

(71) Applicants: Paul Smith, Drayton Valley (CA); Daniel S. Smith, Drayton Valley (CA); Darrell Boulter, Drayton Valley (CA); Frank Murray, Drayton Valley (CA); Gregory A. Hartman, Drayton Valley (CA)

(72) Inventors: Paul Smith, Drayton Valley (CA); Daniel S. Smith, Drayton Valley (CA); Darrell Boulter, Drayton Valley (CA); Frank Murray, Drayton Valley (CA); Gregory A. Hartman, Drayton Valley (CA)

(73) Assignee: R.I.D.E. INC., Drayton Valley, AB (CA)

(21) Appl. No.: 13/643,779

(22) PCT Filed: Apr. 29, 2011
(86) PCT No.: PCT/CA2011/050263

§ 371 Date: Nov. 1, 2012

Related U.S. Application Data
(60) Provisional application No. 61/329,384, filed on Apr. 29, 2010.

(51) Int. Cl. A62B 1/02

(52) U.S. Cl. 182/10

(57) ABSTRACT

A supported davit arm extension assembly for a descent apparatus comprising an escape shuttle suspended from a cable defining a descent path from an initial point at a receiver of a platform to a terminal point proximate to a ground surface. The extension assembly comprises a davit arm extending above the platform and secured to the receiver, and a fall arrest trolley operatively coupled to the shuttle at a first end and terminating at a second end extending substantially away from the terminal point. The second end of the fall arrest trolley has a securement point for connection to and support of a load, such as a worker, by an overhead fall arrest. While the shuttle is docked with the receiver, the fall arrest trolley extends over the platform, supported by the davit arm, and facilitates substantially unfettered movement of the worker around the platform. As the worker enters the shuttle, it is disengaged from the receiver and follows the descent path of the cable toward the ground surface. The second end of the fall arrest trolley rides along the davit arm and onto the cable and is thereafter supported thereon through the descent of the shuttle.

### TECHNICAL FIELD

The present disclosure relates to a descent apparatus suspended from a cable for escaping an elevated platform and in particular for a supported davit arm extension assembly for use with such apparatus.

### INTRODUCTION

In order to protect rig workers in the event of an accidental fall off of an elevated rig platform, typically a plurality of lanyards are connected at a first end to the rig platform on which the worker is to conduct work, and at a second end to a harness worn by the worker. In some example embodiments, two lanyards are employed. A first lanyard (sometimes referred to as the working lanyard) typically extends substantially horizontally from a structure of the platform such as a railing or a wall and connects to the harness behind the worker at waist level. A second lanyard (sometimes referred to as the overhead fall arrest) typically extends substantially vertically downward from an overhead structure and connects to the harness behind the worker at shoulder level. The plurality of lanyards permits the rig worker to have relatively free range of motion to perform tasks and substantial freedom to move about the platform, but safely maintains the rig worker in a position from which he or she may be rescued in the event of falling off the platform if struck by a moving object or if disoriented or unconscious, for example, as a result of an explosion. The use of such lanyards is typically mandated by health and safety regulations in effect in such environments.

As described in U.S. patent application Ser. No. 11/687,145 filed Mar. 16, 2007 by Boscher et al., which is incorporated by reference in its entirety herein, and entitled “Apparatus for escaping area of accident”, if, in an emergency situation, such as a fire or explosion, a rig worker attempts to escape an elevated platform by jumping into an escape apparatus or escape shuttle docked at the platform, the rig worker is to disconnect both lanyards before entering into the escape apparatus. In some cases, governing health and safety regulations may mandate that the worker re-connect to lanyards tethered to the escape apparatus before undocking it from the platform. Each of these steps may take some time, even if the rig worker is relatively calm. In fact, when evacuating the platform using the escape shuttle, the rig worker is more likely to be in an excited state, which may complicate and delay the disconnection and re-connection of lanyards.

Boscher et al. disclose an apparatus for escaping the area of an accident on a drilling rig platform or the like. Emergency escape from the platform follows a path defined by at least one cable extending between the platform and a remote, terminal location. The apparatus includes a frame in which a top of the frame is located above a bottom of the frame when the frame is erect. A locking mechanism is adapted to interlock with a mating portion on the platform to prevent the frame from travel away from the platform when the locking mechanism engages the mating portion. A disengager is connected to the locking mechanism and has a foot receiving surface region upon which force can be applied to displace the disengager between a first, engaged position and a second position to disengage the locking mechanism from the mating portion. The frame will travel away from the platform to the terminal location under gravity when the locking mechanism is disengaged. The apparatus further comprises an overhanging member extending out horizontally from a platform-facing side of the frame, which has a jutting end adapted to receive a lanyard reel. The overhanging member extends into the region of the platform while the frame is docked with the platform. A distal end of the overhanging member is unsupported. Support for the overhanging member is provided by securing a proximal end of the member to the frame. Lanyards extend between the harness of the rig worker and the distal end of the overhanging member of the apparatus while the rig worker works on the platform. This dispenses with any disconnection and/or re-connection protocol when the escape apparatus is to be engaged by the rig worker. The lanyards further assist in preventing the rig worker from falling out of the apparatus as it descends from the platform to a ground surface away from the platform.

The apparatus described in Boscher et al. comprises a heavy frame including a pair of side walls, which support a plurality of sheaves mounted to the side walls. The sheaves on each side wall engage one of a pair of cables extending from the platform to a ground surface away from the platform, which defines the descent path of the escape apparatus. As a result of the foregoing, a minimum size, structure and composition of the side walls of the apparatus are constrained in that they are of sufficient size and rigidity to support three or four sheaves thereon. The sturdiness and rigidity of the frame adequately supports the overhanging member at its proximal end, with the distal end being unsupported, such that when the overhead fall arrest is suspended from it, such configuration remains in accordance with typical health and safety regulations regarding a minimum load that may be supported by the overhead fall arrest.

However, since the sheaves pass through the side wall of the apparatus, which is maintained in a generally vertical orientation for the safe transport of personnel, the steepness of the angle of descent of the apparatus is also somewhat constrained, which imposes limitations on the positioning of the cable both at the elevated platform end and at the ground surface, especially given that at least two cables are used. Moreover, considerable site preparation may be called for to ensure that there remains clearance along the descent path for both the cable and the apparatus. Further, the weight of the apparatus imposes constraints in terms of effort and equipment to raise the apparatus to return it to a docked position after use.

U.S. patent application Ser. No. 12/617,999 filed Nov. 13, 2009 by Hartman et al. (“Hartman No. 1”), which is incorporated by reference in its entirety herein, and entitled “Single Cable Descent Control Device”, discloses a single cable descent control device comprising a pair of rotors with corresponding frames of conductive material mounted on a common central axle on either side of a drive pulley. The pulley is adapted to sit above a single descent cable. An enclosure is suspended from the device. Disposed along at least one surface of each of the rotors or of the corresponding frames or both, is a series of magnets such that rotation of the rotors relative to the frames induces eddy currents that oppose the magnetic field and create a rotational braking force providing precise and controllable descent of the enclosure with little or no mechanical wear or risk of overheating. In this configuration, constraints on the size of the enclosure are dispensed with, as are corresponding limitations on the positioning and angle of descent of the cable. Further, significant labour and material savings in manufacturing the enclosure may be obtained from the resulting simplicity of design. The device may be used in numerous other applications, including without limitation, permitting controlled descent of gondolas or chairs from ski lift operations when normal lift operation is temporarily precluded. No overhead fall arrest mechanism is disclosed by Hartman No. 1.

PCT International Application No. PCT/CA2011/050055, filed Feb. 1, 2011 by Hartman et al. (“Hartman No. 2”), which is incorporated by reference in its entirety herein, and entitled “Movable Cable Loop Descent System”, discloses a movable cable loop descent system that comprises a cable for forming into a loop, a receiver for attachment to a structure at an initial point having a receiver pulley for engaging the cable loop around it, a brake assembly having a drive pulley for engaging and being rotated by the cable loop at a terminal point, the brake assembly for slowing a rate of travel of the cable loop around the pulleys and a carriage for attachment to the cable loop at a point for supporting a load and for movement between the initial point and the terminal point as the cable loops around the pulleys. A number of kits comprising the cable, the receiver, the brake assembly and the carriage, with or without a mount or a drive-on anchor are also disclosed. As was the case with Hartman No. 1, no overhead fall arrest mechanism is disclosed by Hartman No. 2.

While no overhead fall arrest is disclosed in respect of either of Hartman No. 1 or Hartman No. 2, such an overhead fall arrest may be appropriate to satisfy any health and safety regulations that may call for an overhead fall arrest. However, because the escape apparatus is suspended below the cable, simply providing an overhanging member connected at a proximal end to the escape apparatus to which the overhead fall arrest may be connected may not be appropriate, because it is unlikely that such overhanging member will on its own have the rigidity or provide support to satisfy typical health and safety regulations. Furthermore, an unsupported distal end of the overhanging member may come into contact with and potentially interfere with the operation of the cable, and thus adversely impact the operation of the escape apparatus suspended from it and which travels along the cable.

### BRIEF DESCRIPTION OF THE DRAWINGS

FIG. 1 is a side view of an example embodiment of a cable-based descent apparatus having a supported davit arm extension assembly in accordance with an example embodiment of the present disclosure;

FIG. 2 is a rear perspective view of the shuttle trolley, fall arrest trolley, escape shuttle and receiver of the example embodiment of FIG. 1,

FIG. 3 is a front perspective view of the shuttle trolley, fall arrest trolley, escape shuttle and receiver of the example embodiment of FIG. 1;

FIG. 4 is a fragmentary side view of the receiver, davit arm, and fall arrest trolley of the example embodiment of FIG. 1;

FIG. 5 is a fragmentary perspective view of the chain, clip and latch assembly of an example embodiment of the present disclosure; and

FIG. 6 is a side view of the descent apparatus and fall arrest trolley of the example embodiment of FIG. 1, when disengaged from the receiver.

Like reference numerals are used in the drawings to denote like elements and features.

### DESCRIPTION

The present disclosure provides a fall arrest trolley, a davit arm and a supported davit arm extension assembly for an escape shuttle suspended from a cable defining a descent path from an initial point at a receiver of a platform to a terminal point proximate to a ground surface. The extension assembly comprises a davit arm extending above the platform and secured to the receiver, and a fall arrest trolley operatively coupled to the shuttle at a first end and terminating at a second end extending substantially away from the terminal point. The second end of the fall arrest trolley has a securement point for connection to and support of a load, such as a worker, by an overhead fall arrest. While the shuttle is docked with the receiver, the fall arrest trolley extends over the platform, supported by the davit arm, and facilitates substantially unfettered movement of the worker around the platform. As the worker enters the shuttle, it is disengaged from the receiver and follows the descent path of the cable toward the ground surface. The second end rides along the davit arm and onto the cable and is thereafter supported thereon throughout the descent of the escape shuttle.

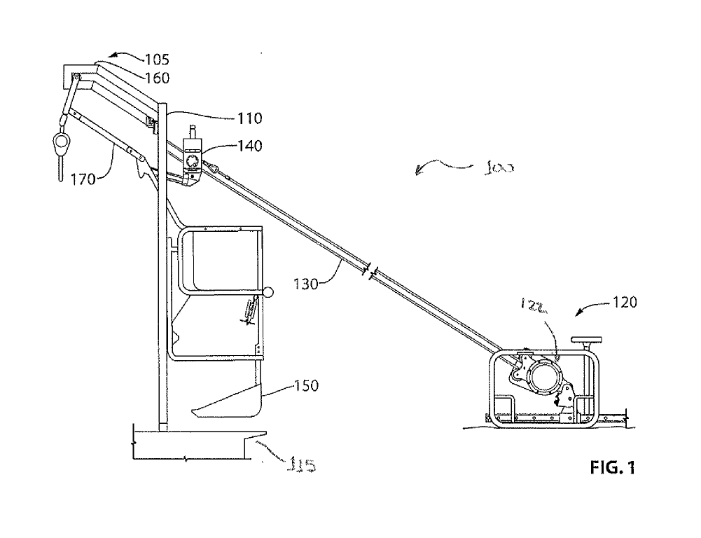

Reference is now made to FIG. 1, which illustrates an example cable-based descent apparatus 100 and an example embodiment of the davit arm extension assembly 105 of the present disclosure, for use with the apparatus 100. The example descent apparatus 100 comprises a receiver 110, a base 120, a cable 130 and an escape shuttle 150. The receiver 110 is located on an elevated platform 115 from which rapid evacuation of persons located thereon may be appropriate in certain scenarios. One example of such a platform 115 is that of a drilling rig commonly used in the oil and natural gas industries. The base 120 is located on the ground below the platform 115, and at some distance away from the structure. The cable 130 extends from the receiver 110 to the base 120, defining a descent path from an initial point at the platform 115 to a terminal point at the ground. The shuttle 150 is suspended from the cable 130 and is free to travel along the length of the descent path defined by the cable 130.

In the example embodiment of FIG. 1, first and second ends of the cable 130 are formed into a continuous loop that extends around sheaves at the receiver 110 and base 120. In such embodiments, the shuttle 150 is secured to the cable 130 at one point and moves as the cable loop is moved about the sheaves. In other example embodiments, the cable 130 comprises a linear segment having a first end secured at the initial point and a second end secured at the terminal point. In such embodiments, the shuttle 150 slidably engages the cable 130, for example, via a sheave rotatably mounted to the shuttle, allowing the shuttle to travel along the length of the cable 130.

The shuttle 150 can be in a so-called “docked” position, as shown in FIG. 1. When in a docked position, the shuttle 150 engages the receiver 110 and permits entry to the shuttle 150 from the platform 115 via the receiver 110.

The example davit arm extension assembly 105 comprises a davit arm 160 and a fall arrest trolley 170. The davit arm 160 is secured to the receiver 110 and extends above the platform 115. The fall arrest trolley 170 is operatively coupled to the shuttle 150 at a first end and terminates at a second end extending substantially away from the terminal point.

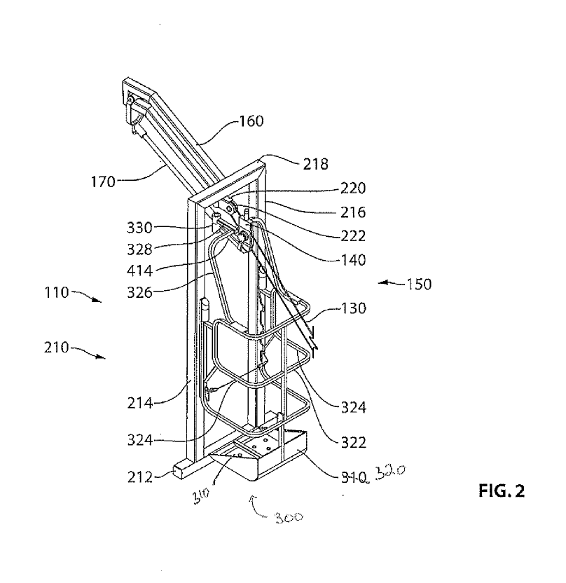

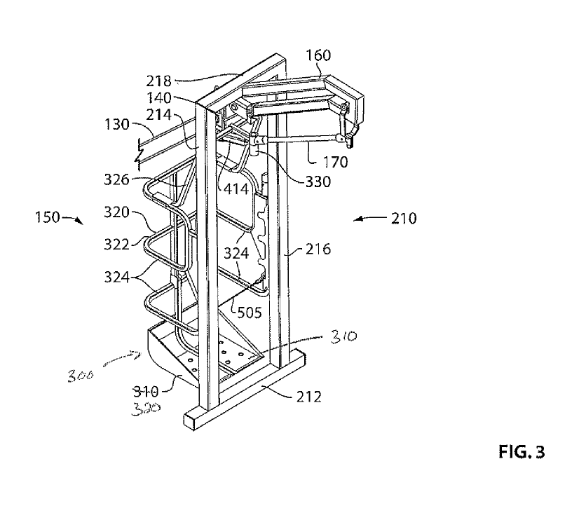

Reference is now made to FIGS. 2 and 3, in which the receiver 110 is shown in greater detail. The receiver 110 is adapted to engage the shuttle 150 when the shuttle 150 is in a docked position. For purposes of clarity of description only, the end of the shuttle 150 that faces the receiver 110 (in FIG. 2 to the left and in FIG. 3 to the right) is referred to as the front end of the shuttle 150 from which, in some example embodiments, personnel and equipment may embark, and disembark, the shuttle 150. The end of the shuttle 150 that is to the right in FIG. 2 and to the left in FIG. 3 is referred to as the back end of the shuttle 150. Similar references to front and back will be applied consistently throughout the present disclosure.

In some example embodiments, the receiver 110 comprises a threshold 210 for allowing personnel and materials to pass between the platform 115 and the shuttle 150 in a docked position, and for supporting the davit arm extension assembly 105. In some example embodiments, the threshold 210 comprises a substantially horizontal bottom sill 212, a pair of substantially vertically extending jambs 214, 216 and a substantially horizontal header 218. The threshold 210 and its components can be made, by way of non-limiting example, from structural steel, or with any suitable other material.

The sill 212 is, in some example embodiments, positioned substantially flush with or close to the same level as a floor surface of the platform 115. When the shuttle 150 is in the docked position, the sill 212 is, in some example embodiments, positioned substantially flush with or close to the same level as a floor of the shuttle 150.

The jambs 214, 216 are situated on or beside the sill 212 and are spaced apart by a width that permits easy entry of a rig worker and/or equipment between them and onto the shuttle 150 when in the docked position. In some example embodiments, the jambs 214, 216 are spaced apart by substantially the width of the shuttle 150.

The jambs 214, 216 extend substantially vertically upward and are terminated by the header 218. The height of the jambs 214, 216 provides vertical clearance between the sill 212 and the header 218 to accommodate a rig worker or other personnel passing through the threshold 210 and onto the shuttle 150 when in the docked position.

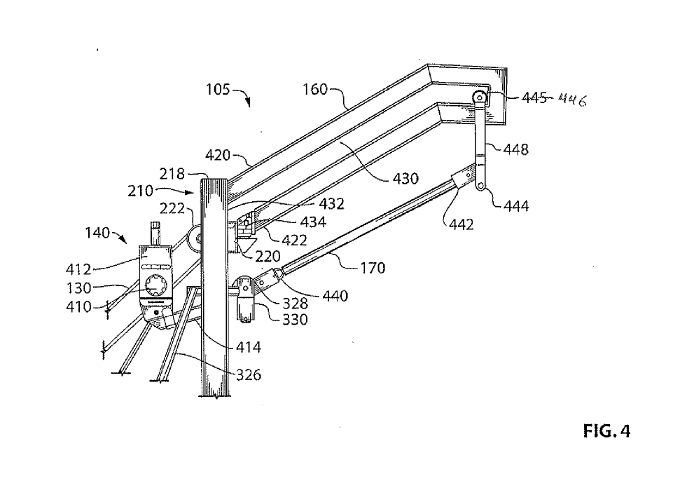

The davit arm 160 is secured to the receiver 110. Reference is now made to FIG. 4, which shows an example embodiment of the davit arm 160 in greater detail. In embodiments wherein the receiver 110 comprises a threshold 210, which in turn comprises a header 218, the davit arm 160 is rigidly secured, for example by welding, at a first end 420 to a platform-facing side of the header 218. In these embodiments, the davit arm 160 extends forwardly (that is, toward the platform 115) from the header 218 over the platform 115. A second end 422 of the davit arm 160 extends back under the davit arm 160 and towards the threshold 210, below the first end 420 and the header 218, as shown in FIG. 4. Thus, a travel path 430 is defined between upper and lower portions of the davit arm 160, extending from the point at which the davit arm 160 extends back under itself to a gap 432 between the header 218 and the second end 422 of the davit arm 160.

The davit arm 160 can be made of any material suitable for the components of the threshold 210, described above. In some example embodiments, the davit arm 160 is made of the same material as the components of the threshold 210, which in some example embodiments is structural steel.

The davit arm 160 extends from header 218 by a distance selected to substantially match the length of the fall arrest trolley 170 (the length of which can be selected as described below), before the second end 422 of davit arm 160 extends back under as described above. In some example embodiments, this distance is longer than the length of the fall arrest trolley 170.

In some example embodiments, the davit arm 160 extends forwardly from the header 218 and upwardly away from the platform 115, as shown in FIG. 4. The angle at which the davit arm 160 extends relative to the platform 115 may, in some example embodiments, be selected such that davit arm 160 is substantially parallel to the descent path defined by the cable 130. In such embodiments, the travel path 430 is substantially along a direction collinear with the descent path defined by the cable 130 but extending over the platform 115.

In the example embodiment shown in FIGS. 2, 3 and 4, the second end 422 of the davit arm 160 comprises a receiver cable support 220. In such embodiments, the receiver cable support 220 comprises the initial point from which the cable 130 extends. Receiver cable support 220 is mounted to the second end 422 of the davit arm 160 and supports the weight of the cable 130 and any load suspended therefrom, such as the shuttle 150 and any other load supported by the shuttle 150. In some example embodiments, the receiver cable support 220 is rigidly secured, by way of non-limiting example by welding, to the second end 422 of the davit arm 160.

In the example embodiments shown in FIGS. 2, 3 and 4, the cable 130 comprises a continuous loop, and the receiver cable support 220 comprises a receiver pulley 222, which allows the continuous loop cable 130 to rotate around the receiver pulley 222.

In the example embodiments shown in FIGS. 2, 3 and 4, the receiver cable support 220 is pivotally secured, in some example embodiments, by hinging, to the second end of the davit arm 160 via first pivot gear 434. In some example embodiments, a substantially horizontal rotation of the cable path relative to the davit arm 160, of substantially up to ±15 degrees, is permitted, which may facilitate convenient positioning of the base 120 without imparting undue stress on the davit arm 160 or introducing unwieldy and potentially dangerous gaps between the floor of the shuttle 150 and the sill 212 of the threshold 210 and the platform 115 floor.

Referring again to FIG. 4, the fall arrest trolley 170 has a first end 440, a second end 442 and a securement point 444. The first end 440 is operatively coupled to the shuttle 150. In some example embodiments, the first end 440 comprises a ball joint. The second end 442 extends substantially away from the base 120. The securement point 444 is connected to the fall arrest trolley 170 at any point along its length. In the embodiment shown in FIG. 4, the securement point 444 is connected to the fall arrest trolley 170 at or proximate to the second end 442.

The fall arrest trolley 170 is a generally rigid, elongate member made of a material with sufficient structural support to support a load, such as a rig worker. Any material suitable for construction of the davit arm 160 or the components of the threshold 210 would be suitable. In some example embodiments, the same material could be used for the construction of each of the components of the threshold 210, the davit arm 160 and the fall arrest trolley 170.

A first end 440 of the fall arrest trolley 170 is operatively coupled to the shuttle 150 such that, when the shuttle 150 moves along the cable 130, the fall arrest trolley 170 will move along with the shuttle 150. In some example embodiments, the fall arrest trolley 170 is pivotally connected to the shuttle 150 via a second pivot gear 330, permitting the fall arrest trolley 170 to rotate at least partially, in a substantially horizontal plane. In some example embodiments, the first end 440 of the fall arrest trolley 170 is connected to a second part of the pivot gear 330, and the shuttle 150 is connected to a first part of the pivot gear 330. The second pivot gear 330 provides freedom of rotation of substantially up to ±15 degrees, which may facilitate suitable and convenient positioning of the base 120 without imparting undue stress on the receiver 110 and without introducing unwieldy and potentially dangerous gaps between the shuttle 150 and the platform 115.

The fall arrest trolley 170 extends substantially upward and away from the base 120 and parallel to the descent path defined by the cable 130. The second end 442 of the fall arrest trolley 170 is supported by the davit arm 160. In the example embodiment shown in FIGS. 2, 3 and 4, the second end 442 is suspended from a supporting sheave 446 that engages the davit arm 160 within the travel path 430. In some example embodiments, the second end 442 is suspended from the supporting sheave 446 via a spacer 448, to maintain a substantially vertical clearance between the fall arrest trolley 170 and the cable 130. In some example embodiments (not shown), the fall arrest trolley 170 is pivotally connected to the spacer 448, via any pivotal connection means previously described.

The securement point 444 permits the securing of a retractable lanyard or a lanyard reel containing a lanyard, such as an overhead fall arrest, to the fall arrest trolley 170. In some example embodiments, the securement point 444 is an aperture in the fall arrest trolley 170 to which the lanyard can be clipped. In some example embodiments, the securement point 444 is positioned at or proximate to the second end 442 of the fall arrest trolley 170. In the example embodiment shown in FIGS. 2, 3 and 4, the securement point 444 is coincident with and secured to the spacer 448 separating the fall arrest trolley 170 from the supporting sheave 446.

Referring back to FIG. 2, while the shuttle 150 is in the docked position, the fall arrest trolley 170 extends across and over the platform 115 so that a rig worker's overhead fall arrest may be secured to the securement point 444 of the fall arrest trolley 170 while the rig worker is working on the platform 115. The sturdiness and rigidity of the connection between the first end 420 of the davit arm 160 (which supports the fall arrest trolley 170 via the supporting sheave 446 and spacer 448) and the header 218 is sufficient to support a load such as a falling rig worker connected by an overheard fall arrest and adequately supports the supporting sheave 446 of the fall arrest trolley 170 while the shuttle 150 is in the docked position, such that when an overhead fall arrest is secured to the securement point 444, such configuration remains in accordance with typical health and safety regulations regarding a minimum load that can be supported along the overhead fall arrest.

Salient aspects of the cable-based descent apparatus 100, with which the davit arm extension assembly 105 may be used, will now be described in further detail. Referring back to FIG. 1, the base 120 engages the cable 130 at the terminal point to provide the cable 130 with support.

The base 120 is located on the ground below the platform 115, and some distance away from the platform 115. The distance from the platform 115 at which the base 120 is placed is selected based on the desired angle of descent at which the shuttle 150 should travel.

In the example embodiment of FIG. 1, in which the first and second ends of the cable 130 are formed into a continuous loop, the base 120 comprises a base pulley 122 around which the continuous loop of cable 130 rotates. In some example embodiments, the base 120 comprises a braking mechanism to slow the rotation of the continuous loop cable 130 about the base pulley 122 in a controlled and safe fashion. By way of non-limiting example, such a braking mechanism may be that which is described in Hartman No. 2.

Again referring to FIG. 1, the cable 130 extends from the receiver 110 to the base 120, defining a descent path from the platform 115 to the ground. Cable 130 is made from material sufficiently strong to support the weight of the shuttle 150 and any other load that may be suspended from the cable 130, such as loads supported by the shuttle 150. Such loads may include personnel, such as a rig worker, to be evacuated from the platform 115, or may also include equipment to be moved between the platform 115 and the ground via the cable-based descent apparatus 100. Non-limiting example materials from which cable 130 may be made include braided wire rope (6×36MC stainless wire rope), synthetic rope, or composite.

Referring again to FIGS. 2 and 3, the shuttle 150 is shown. The shuttle 150 is a structure that, when supported by cable 130, supports the weight of a load, such as a rig worker or equipment to be transported from the platform 115 to the ground. The particular form, structure and size of the shuttle 150 may vary in accordance with local regulations or customs or both. In the example embodiment of FIGS. 2 and 3, the shuttle 150 comprises a shuttle trolley 140 for engaging the cable 130 and a substantially vertically extending envelope or cradle 300 suspended from the shuttle trolley 140. In some example embodiments, the cradle 300 comprises a floor 310, an open top and front and at least one barrier 320 on the rear and sides. In some example embodiments, the shuttle 150 may comprise a seat (not shown) or a “T” handle (not shown).

Referring now to FIG. 4, an example embodiment of the shuttle trolley 140 is shown that comprises an internal sheave (not shown) for engaging the cable 130, a housing 412 for partially enclosing the sheave (not shown) and attachment means 414 for suspending the cradle 300 therefrom.

Shuttle trolley 140 is movably mounted to cable 130 by engaging an outer circumferential surface of sheave (not shown) with an upper surface of cable 130. In the example embodiment of FIG. 4, wherein the cable 130 comprises a continuous loop rotatable about pulleys 222, 122, the shuttle trolley 140 is secured at a point along the continuous loop cable 130 so as to be movable along the descent path defined by the cable 130 as the cable 130 is rotated about the pulleys 222, 122. In such embodiments, the housing 412 of shuttle trolley 140 surrounds the cable 130 at two points, but shuttle trolley 140 is secured to the cable 130 at one point. For example, as shown in FIG. 4, an upper segment of the continuous loop of cable 130 passes through the housing 412 and above the sheave (not shown), without engaging the sheave (not shown), whereas a corresponding lower segment of the continuous loop of cable 130, directly adjacent to said upper segment, both passes through housing 412 and engages sheave (not shown) as previously described.

In the example embodiment shown in FIG. 4, attachment means 414 is an elongate rod extending from the housing at a first end, and terminating at a second end to which the cradle 300 is attached. In some embodiments, the second end is pivotally attached to the cradle 300 via pivot means 330.

In some example embodiments, the cable 130 is fixed, that is, first end of the cable 130 is secured to the receiver cable support 220 and the second end of the cable 130 is secured to the base 120. The shuttle trolley 140 may, in some example embodiments, comprise a braking mechanism (not shown) to slow the movement of the shuttle trolley 140, relative to the cable 130, in a controlled and safe fashion. By way of non-limiting example, such a braking mechanism could be that which is described in Hartman No. 1.

Referring again to FIGS. 2 and 3, the cradle 300 comprises a floor 310, an open top and front and at least one barrier 320 on the rear and sides. The floor 310 provides support to the load contained within the shuttle 150, such as an escaping rig worker or equipment to be transported between the platform 115 and the ground. The barrier 320 comprises a back portion 322 covering the back of the shuttle 150 and side portions 324 covering the left and right sides of the shuttle 150. The barrier 320 also comprises an overhead member 326 extending upward from one side portion 324 at one end, extending over the floor 310 of the cradle 300 and back down to engage the other side portion 324 at another end. The barrier 320 serves to prevent the load being transported by the shuttle 150 from falling out of the shuttle 150 while it is in motion. In some example embodiments, a lanyard, or a retractable lanyard reel containing a lanyard, such as the working lanyard of a rig worker, is secured to the shuttle 150 for example, by securing the lanyard to the rear portion 322 of the barrier 320.

In the example embodiment shown in FIGS. 2, 3 and 4, the cradle 300 is attached to the shuttle trolley 140 via a second pivot gear 330, so that the cable 130 can be rotatably moved in a substantially horizontal plane up to substantially ±15 degrees relative to the shuttle 150. As shown in FIG. 3, the second end of the attachment means 414 connects to a first end of the second pivot gear 330. The overhead member 326 of the barrier 320 connects to the second end of the second pivot gear 330 via a shunt 328 as shown in FIG. 3. Such a connection facilitates convenient positioning of the cable 130 without imparting undue stress on the shuttle 150 or introducing unwieldy and potentially dangerous gaps between the shuttle 150 and the platform 115.

The shuttle 150 is maintained in the docked position shown in FIG. 1 by securing the barrier 320 of the shuttle 150 to the receiver 110. In some example embodiments, the barrier 320 is secured by securing a front edge of at least one of the side portions 324 of the barrier 320. In some example embodiments, the barrier 320 so secured is comprised of a ferromagnetic material such as steel and the receiver 110 has at least one magnet positioned thereon to engage and magnetically retain the barrier 320, and thus the shuttle 150, when the shuttle 150 is in the docked position.

In example embodiments wherein the shuttle 150 is held in the docked position via magnetic force, the shuttle 150 is disengaged from the receiver 110 and the platform 115 by transferring a load, such as a rig worker, across the threshold 210 of the receiver 110 from the platform 115 to the shuttle 150, that exceeds the total magnetic field strength of the at least one magnet on the receiver 110.

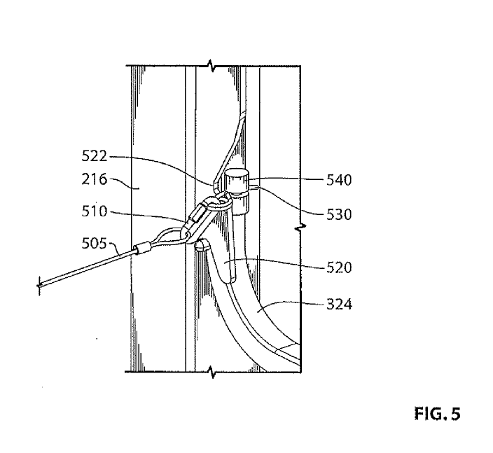

Referring now to FIG. 5, in some example embodiments, the shuttle 150 comprises a detection assembly for detecting entry of a load onto the shuttle 150 from the platform 115. In some example embodiments, the detection assembly is adapted to prevent the shuttle 150 from moving from the docked position unless a load is detected entering the shuttle from the platform 115. In some example embodiments, the detection assembly is a latch and pin assembly. Such an assembly comprises a latch 520, an eyelet 540, a chain or cable 505, and a pin 530.

The latch 520 is provided on at least one of the jambs 214, 216 of the threshold 210. The latch 520 is a downward-facing hook-shaped flange projecting from an outer face of at least one of the jambs 214, 216 for engaging the shuttle 150 when the shuttle 150 is in the docked position. The latch has a notch 522 positioned to align with the eyelet 540, which is mounted on a side portion 324 of the barrier 320, when the shuttle 150 is in the docked position.

The chain or cable 505 is secured at a first end to a side portion 324 of the barrier 320 (not shown in FIG. 5). The cable 505 extends across the front of the shuttle 150 at a height that would be typically engaged by a rig worker entering the shuttle 150. The cable 505 terminates at a second end, which can be removably inserted into a clip or other temporary securement 510.

The pin 530 is removably inserted into the clip 510, such that the pin 530 is free to extend further from the end of the cable 505. The pin 530 is dimensioned to pass through both the notch 522 and the eyelet 540 when the notch 522 and eyelet 540 are aligned.

In order for the shuttle 150 to disengage from the receiver 110 and the platform 115, the shuttle 150 drops down away from the threshold 210. In so doing, the eyelet 540 moves in a downward direction relative to the notch 522. When the pin 530 is disposed both in the notch 522 and the eyelet 540, the pin prevents said downward movement, holding the shuttle 150 in the docked position. The pin 530 may be made of a material that is able to support the weight of the shuttle 150 that the pin 530 will bear when the shuttle 150 is in the docked position.

In the example embodiments comprising the latch and pin assembly, the entry of a rig worker to the shuttle 150 will apply pressure to the cable 505 pulling out the second end of the chain 505, the clip 510 and the pin 530 from the eyelet 540, allowing the shuttle 150 to move in a downward direction, disengaging from the receiver 110 and platform 115.

In operation, the cable 130 may be situated under tension between the receiver 110 beside the platform 115 and the base 120 to define a descending path from the platform 115 to the ground surface. Although the base 120 may be notionally positioned along a line extending normally from the threshold 210 away from the platform 115 and collinearly with the davit arm 160 in order to minimize any gaps between the shuttle 150 and the threshold 210, in some example embodiments, the base 120 may be moved horizontally relative to the orientation of the threshold of the receiver 110, up to substantially ±15 degrees.

The shuttle trolley 140, fall arrest trolley 170 and shuttle 150 may then be raised until the shuttle 150 is in the docked position in engagement with the threshold 210 of the receiver 110 and the platform 115. In those embodiments where the cable 130 is fixed between the receiver 110 and the base 120, the shuttle trolley 140, fall arrest trolley 170 and shuttle 150 may be so raised by pulling on a line, secured to the shuttle 150, from the platform 115. In embodiments where the cable 130 is formed into a loop rotatable about pulleys 222, 122 at the receiver 110 and the base 120, the shuttle trolley 140, fall arrest trolley 170 and shuttle 150 secured to a point along the cable loop 130 may be so raised by rotating the cable loop 130 in a direction to return the shuttle trolley 140, fall arrest trolley 170 and shuttle 150 to the docked position. In some example embodiments, this may be achieved by rotating the base pulley 122 in an appropriate direction.

Once the shuttle 150 has been placed in the docked position in engagement with the threshold 210 and the platform 115, the shuttle 150 may be held in this position by any manner described above. When the shuttle 150 is in the docked position, the overhead fall arrest of a rig worker may be secured to the securement point 444 of the fall arrest trolley 170 which extends over the platform 115 and the working lanyard of the rig worker may be secured to the barrier 320 of the shuttle 150, at either the rear portion 322 or one of the side portions 324. The supported davit arm extension assembly 105, namely the fall arrest trolley 170 and the davit arm 160, serve to permit a rig worker to be secured by the overhead fall arrest and working lanyard to the shuttle 150, rather than to the platform 115, with sufficient support to satisfy health and safety regulations regarding a minimum load that may be supported, yet with sufficient freedom to move about the platform 115 to perform assigned duties. At this point, the shuttle 150 is ready for operation and the rig worker may safely perform assigned activities on the platform 115, with substantially unfettered movement about the platform 115.

In the event of a situation which calls for evacuation of the rig worker to the ground surface, the rig worker merely moves through the threshold 210 and into the shuttle 150. In some example embodiments, the shuttle 150 is held in the docked position via magnets, and the downward force produced by the weight of the rig worker overcomes the magnetic force holding the shuttle 150 in the docked position, allowing the shuttle 150 to disengage from the receiver 110. In some example embodiments, the shuttle is held in the docked position via the aforementioned latch and pin assembly, and pressure is applied on the chain 505, causing the second end of the chain 505, the clip 510 and the pin 530 to withdraw from the eyelet 540. This allows the shuttle 150 to move downwardly away from the receiver 110, thus disengaging the receiver 110.

When the shuttle 150 is disengaged from the threshold 210 and platform 115, the shuttle trolley 140 and the shuttle 150 begin a downward descent along the cable 130 to the ground surface. A braking mechanism (not shown but which, in those example embodiments where the cable 130 is fixed between the receiver 110 and the base 120, may be mounted over or inside the shuttle trolley 140 and in those example embodiments where the cable 130 is formed in a loop to rotate about the receiver and base pulleys 222, 122, may be mounted inside or operatively coupled to the base 120) allows the shuttle 150 to descend toward the ground surface in a safe and controlled fashion.

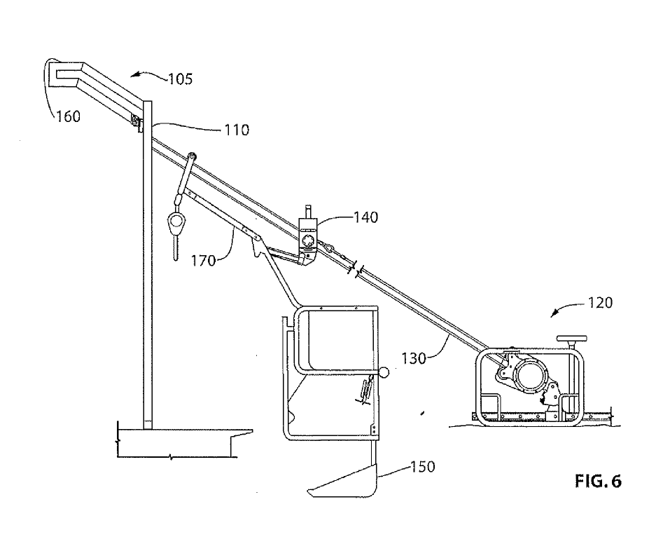

As the shuttle 150 and shuttle trolley 140 descend along the cable path to the ground surface, the supporting sheave 446 attached to the shuttle trolley 140 via the fall arrest trolley 170 rides along the descending travel path 430 of the lower portion of the davit arm 160, passes across the threshold 210 and over the cable support 220, via the gap 432, and continues moving downward along the cable 130. As the shuttle trolley 140 descends along the cable 130, the fall arrest trolley 170 is supported by the cable 130 behind the shuttle trolley 140 and follows the descent path of the cable 130, as shown in FIG. 6. In some example embodiments, the pivotable connection of the second end of the fall arrest trolley 170 to the spacer 448 permits the supporting sheave 446 to move easily to follow the position of the davit arm 160, the cable support 220 and eventually the cable 130.

Because the rig worker's overhead fall arrest is already connected to the securement point 444 of the fall arrest trolley 170 and the working lanyard is secured to the barrier 320 of the shuttle 150, the overhead fall arrest and the working lanyard do not need to be disconnected by the rig worker before disembarking from the platform 115, and thus pose no impediment to the rig worker evacuating the platform 115 in the shuttle 150.

When the shuttle trolley 140, shuttle 150 and fall arrest trolley 170 are moving down the descent path defined by the cable 130, the supporting sheave 446 is supported by the tension in the cable 130. Since the rig worker is no longer on the platform 115 but inside the shuttle 150, this is not problematic. Because the support sheave 446, to which the second end of the fall arrest trolley 170 is secured, remains supported by the cable 130, the likelihood that the fall arrest trolley 170 will become tangled with the cable 130 or the shuttle 150 is minimized.

In the event that the rig worker falls out of the shuttle 150, the overhead fall arrest secured to the securing means 444 of the fall arrest trolley 170 and the working lanyard secured to the barrier 320 of the shuttle 150 will safely maintain the rig worker in a position proximate to the shuttle 150 as it continues its descent to the ground surface, until the rig worker may land on the ground surface and be disengaged from the overhead fall arrest and the working lanyard.

If the rig worker remains in the shuttle 150, the shuttle 150 will eventually touch down on the ground surface, at which point the rig worker may be disengaged from the overhead fall arrest and the working lanyard and exit the shuttle 150.

Once the shuttle 150 has touched down, the shuttle trolley 140, shuttle 150 and fall arrest trolley 170 may be re-positioned in the docked position in engagement with the receiver 110 and platform 115 as described above, ready for future use.

According to a first broad aspect of the present disclosure, there is provided a supported davit arm extension assembly for an escape shuttle suspended from a cable defining a descent path from an initial point at a receiver of a platform to a terminal point proximate to a ground surface, the assembly comprising: a davit arm extending above the platform and secured to the receiver; and a fall arrest trolley operatively coupled to the shuttle at a first end and terminating at a second end extending substantially away from the terminal point, the second end having a securement point for connection to and support of a load, the fall arrest trolley extending over the platform, supported by the davit arm and facilitating substantially unfettered movement of the load around the platform while the shuttle is docked with the receiver, the second end of the fall arrest trolley being adapted to ride along the davit arm and onto the cable when the shuttle disengages from the receiver by entry of the load onto the shuttle, the second end of the fall arrest trolley being thereafter supported on the cable as the shuttle follows the descent path of the cable.

According to a second broad aspect of the present disclosure, there is provided a davit arm for an escape shuttle suspended from a cable defining a descent path from an initial point at a receiver of a platform to a terminal point proximate to a ground surface, the shuttle having operatively coupled thereto, a first end of a fall arrest trolley, the fall arrest trolley terminating at a second end extending substantially away from the terminal point, the second end having a securement point for connection to and support of a load, the fall arrest trolley extending over the platform and facilitating substantially unfettered movement of the load around the platform while the shuttle is docked with the receiver, the davit arm for securement to the receiver and extending above the platform for supporting the second end of the fall arrest trolley and adapted such that the second end of the fall arrest trolley may ride along the davit arm and onto the cable when the shuttle disengages from the receiver by entry of the load onto the shuttle, the second end of the fall arrest trolley being thereafter supported on the cable as the shuttle follows the descent path of the cable.

According to a third broad aspect of the present disclosure, there is provided a fall arrest trolley for an escape shuttle suspended from a cable defining a descent path from an initial point at a receiver of a platform to a terminal point proximate to a ground surface, the receiver having secured thereto a davit arm extending above the platform; the fall arrest trolley being operatively coupled to the shuttle at a first end and terminating at a second end extending substantially away from the terminal point, the second end having a securement point for connection to and support of a load, the fall arrest trolley extending over the platform, supported by the davit arm and facilitating substantially unfettered movement of the load around the platform while the shuttle is docked with the receiver, the second end of the fall arrest trolley being adapted to ride along the davit arm and onto the cable when the shuttle disengages from the receiver by entry of the load onto the shuttle, the second end of the fall arrest trolley being thereafter supported on the cable as the shuttle follows the descent path of the cable.

While the present disclosure is sometimes described in terms of methods, the present disclosure may be understood to be also directed to various apparata including components for performing at least some of the aspects and features of the described methods, be it by way of hardware components or combinations thereof, or in any other manner. Such apparata and articles of manufacture also come within the scope of the present disclosure.

The various embodiments presented herein are merely examples and are in no way meant to limit the scope of this disclosure. Variations of the innovations described herein will become apparent from consideration of this disclosure and such variations are within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combination will become readily apparent upon review of the present disclosure as a whole. The subject matter described herein and in the recited claims intends to cover and embrace all suitable changes in the technology.

Accordingly the specification and the embodiments disclosed therein are to be considered examples only, with a true scope and spirit of the disclosure being disclosed by the following numbered claims:

1. A supported davit arm extension assembly for an escape shuttle suspended from a cable defining a descent path from an initial point at a receiver of a platform to a terminal point proximate to a ground surface, the assembly comprising:
a davit arm extending above the platform and secured to the receiver; and
a fall arrest trolley operatively coupled to the shuttle at a first end and terminating at a second end extending substantially away from the terminal point, the second end having a securement point for connection to and support of a load,
the fall arrest trolley extending over the platform, supported by the davit arm and facilitating substantially unfettered movement of the load around the platform while the shuttle is docked with the receiver,
the second end of the fall arrest trolley being adapted to ride along the davit arm and onto the cable when the shuttle disengages from the receiver by entry of the load onto the shuttle, the second end of the fall arrest trolley being thereafter supported on the cable as the shuttle follows the descent path of the cable.

2. The supported davit arm extension assembly according to claim 1, wherein the terminal point comprises a base for engaging the cable.

3. The supported davit arm extension assembly according to claim 1, wherein the shuttle comprises a shuttle trolley for engaging the cable.

4. The supported davit arm extension assembly according to claim 3, wherein the shuttle trolley comprises a sheave for positioning on the cable.

5. The supported davit arm extension assembly according to claim 3, wherein the shuttle comprises a cradle for engaging the shuttle trolley.

6. The supported davit arm extension assembly according to claim 5, wherein the cradle is in pivotal engagement with the shuttle trolley.

7. The supported davit arm extension assembly according to claim 1, wherein the shuttle comprises a detection assembly for detecting entry of the load onto the shuttle from the platform.

8. The supported davit arm extension assembly according to claim 7, wherein the shuttle is inhibited from disengaging unless the detection assembly detects entry of the load onto the shuttle from the platform.

9. The supported davit arm extension assembly according to claim 7, wherein the detection assembly is a latch and pin assembly.

10. The supported davit arm extension assembly according to claim 1, wherein the receiver comprises a threshold comprising a header supported by a plurality of substantially vertically extending jambs, a first end of the davit arm being secured to the header.

11. The supported davit arm extension assembly according to claim 10, wherein a second end of the davit arm extends back under the header.

12. The supported davit arm extension assembly according to claim 11, wherein the second end of the davit arm terminates at a cable support for engaging the cable at the initial point.

13. The supported davit arm extension assembly according to claim 12, wherein the cable support is in pivotal engagement with the second end of the davit arm.

14. The supported davit arm extension assembly according to claim 12, wherein the cable is formed into a loop and the cable support comprises a receiver pulley about which the loop extends.

15. The supported davit arm extension assembly according to claim 14, wherein the cable loop extends around a base pulley at the terminal point and the base comprises a brake assembly for slowing a rate of travel of the cable loop around the pulleys.

16. The supported davit arm extension assembly according to claim 12, wherein the cable is secured to the cable support and the shuttle comprises a brake assembly for slowing a rate of travel of the shuttle along the cable.

17. The supported davit arm extension assembly according to claim 1, wherein the securement point is proximate to the second end of the fall arrest trolley.

18. The supported davit arm extension assembly of claim 1, wherein the shuttle is magnetically secured to the receiver while docked.

19. The supported davit arm extension assembly according to claim 1, wherein the terminal point may be moved substantially horizontally up to a predetermined angle from a position normal to the receiver.

20. The supported davit arm extension assembly according to claim 17, wherein the predetermined angle is substantially about ±15 degrees.

21. The supported davit arm extension assembly according to claim 20, wherein the second end of the fall arrest trolley comprises a sheave for riding on the track and the cable.

22. The supported davit arm extension assembly according to claim 21, wherein the second end of the fall arrest trolley is in pivotable engagement with the sheave.

23. A davit arm for an escape shuttle suspended from a cable defining a descent path from an initial point at a receiver of a platform to a terminal point proximate to a ground surface, the shuttle having operatively coupled thereto, a first end of a fall arrest trolley, the fall arrest trolley terminating at a second end extending substantially away from the terminal point, the second end having a securement point for connection to and support of a load, the fall arrest trolley extending over the platform and facilitating substantially unfettered movement of the load around the platform while the shuttle is docked with the receiver,
the davit arm for securement to the receiver and extending above the platform for supporting the second end of the fall arrest trolley and adapted such that the second end of the fall arrest trolley may ride along the davit arm and onto the cable when the shuttle disengages from the receiver by entry of the load onto the shuttle, the second end of the fall arrest trolley being thereafter supported on the cable as the shuttle follows the descent path of the cable.

24. A fall arrest trolley for an escape shuttle suspended from a cable defining a descent path from an initial point at a receiver of a platform to a terminal point proximate to a ground surface, the receiver having secured thereto a davit arm extending above the platform;
the fall arrest trolley being operatively coupled to the shuttle at a first end and terminating at a second end extending substantially away from the terminal point, the second end having a securement point for connection to and support of a load,
the fall arrest trolley extending over the platform, supported by the davit arm and facilitating substantially unfettered movement of the load around the platform while the shuttle is docked with the receiver,
the second end of the fall arrest trolley being adapted to ride along the davit arm and onto the cable when the shuttle disengages from the receiver by entry of the load onto the shuttle, the second end of the fail arrest trolley being thereafter supported on the cable as the shuttle follows the descent path of the cable.
